(19) United States
(12) Patent Application Publication
(10) Pub. No.: US 2006/0179832 A1
(43) Pub. Date: Aug. 17, 2006

(54) O.H.E.G.

(76) Inventor: Glenn Patrick Cooke, Lostwithiel (GB)

Correspondence Address: Glenn Patrick Cooke, Lower Polscoe, Cott Road, Lostwithiel, Cornwall, PL22 0HL, GB

(21) Appl. No.: 11/350,330

(22) Filed: Feb. 9, 2006

(30) Foreign Application Priority Data
Feb. 12, 2005 (GB) 0502960.8

(51) Int. Cl. F03B 17/02

(52) U.S. Cl. 60/495

(57) ABSTRACT

A power generating apparatus combining; tidal height energy accumulators 10, a selectively isolated chamber system 42 and a venturi enhanced tidal flow energy generating device 72. Tidal height energy accumulators 10 are provided with first and second power generating means, allowing power to be generated on upward and downward motion of a float member. The incorporation of energy accumulators 10 within the chamber system 42, allows the energy accumulators 10 to be selectively isolated from tidal height changes. The sequential operation of energy accumulators 10 and chamber system 42 enables power generation to be controlled over a period of time. The structure of chamber system 42 diverts tidal flow into the tidal flow energy generating device 72.

This invention concerns power generating apparatus and also power generating arrangements.

There is an increasing need and desire for sustainable energy supplies. Wind power has been harnessed with some success but there are a number of problems encountered with this type of power. One of these problems is the unpredictability of weather and particularly the variable amount and direction of the wind. The tidal movements of the sea are in contrast much more predictable, but to date only limited success has been achieved in producing power using the tidal movement of water.

According to the present invention there is provided power generating apparatus, the apparatus including a power generating unit which unit comprises a float member which floats on water, and a support member to which the float member is movably attached, and power generating means extending between the float member and support member such that when relative movement of the float member takes place, this movement causes power to be generated.

First and second power generating means may be provided, such that power is generated by the first power generating means when the float member moves upwardly, and power is generated by the second power generating means when the float moves downwardly.

The power generating means may include a piston and cylinder connected between the float member and support member such that fluid is displaced by virtue of relative movement of the float member. The piston and cylinder may be connected to a hydraulic motor which drives an electricity generator.

Retaining means may be provided to selectively prevent relative movement of the float member, and the retaining means may selectively prevent relative movement of the piston and cylinder. The retaining means may comprise a mechanical lock, or may comprise a valve to prevent fluid flow into or out of the cylinder.

A plurality of power generating means may be provided for each float.

The float may be slidably movable relative to the support member. The support member may extend through a hole in the float member, which may be a substantially central hole. The support member may be mountable to the ground, including mountable to extend upwardly from a river or sea bed.

The float may be hollow such that water can selectively enter thereinto through an inlet, and a selectively operable closure may be provided for the inlet. A flow power generator may be located in or adjacent the inlet such that water passing through the inlet causes electricity or hydraulic power to be generated.

The invention also provides a power generating arrangement, the arrangement including an enclosure locatable in tidal water, and one or more openings in walls of the enclosure such that water can pass into and out of the enclosure as water levels change, with a flow power generator located in or adjacent the or each opening such that water passing therethrough causes power to be generated.

A selectively operable closure may be provided for the or each opening.

The enclosure may be open topped and include upstanding walls which extend above the high tide height of the tidal water. The enclosure walls may be made of concrete.

An outer barrier or enclosure may be provided for the enclosure to protect same from waves. A plurality of adjacent enclosures may be provided. The enclosures may be substantially hexagonal in plan view.

One or more power generating units as defined above may be provided in the or each enclosure.

The fluid in the piston and cylinders may be sea water, which may have been purified.

The arrangement may include control means for selectively controlling the retaining means and/or the selectively operable enclosure closures.

The arrangement may be configured such that water enters or exits the enclosures sequentially, and/or the respective float members rise or fall relative to the respective support members sequentially, such that electricity is generated over a period of time.

The arrangement may also include a plurality of tide turbines which are rotated as the tide rises or falls.

The arrangement may include a plurality of adjacent enclosures with a plurality of tide turbines adjacent thereto, such that the tidal flow of water is urged by the exterior of the enclosures through the tide turbines.

Alternate groups of enclosures and tide turbines may be provided with the alternate enclosures urging the flow of water through the respective tidal turbines.

One or more wind turbines may be provided mounted on the enclosures or the power generating units located therein.

Embodiments of the present invention will now be described by way of example only and with reference to the accompanying drawings, in which:

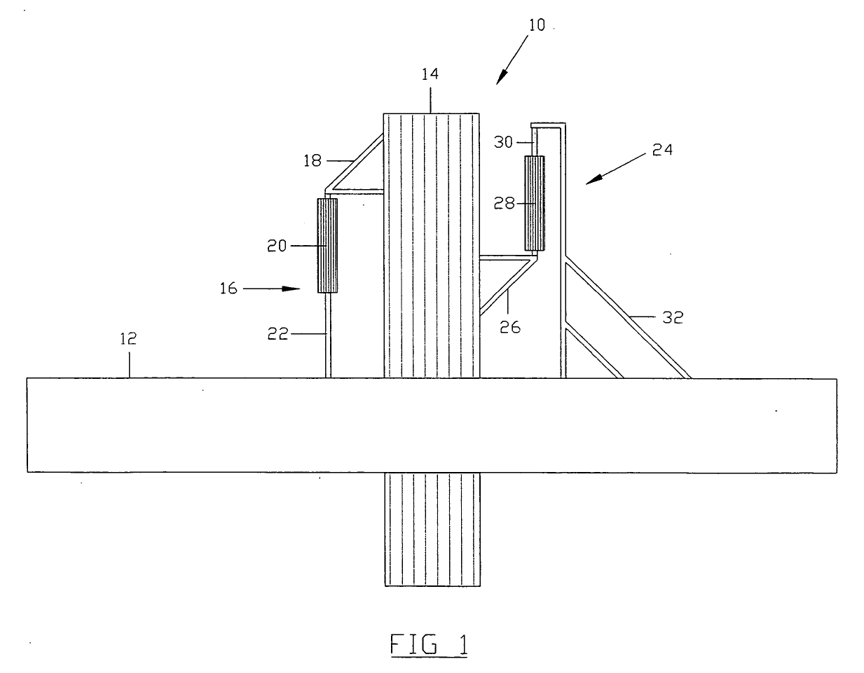

FIG. 1 is a diagrammatic side view of a first power generating apparatus according to the invention;

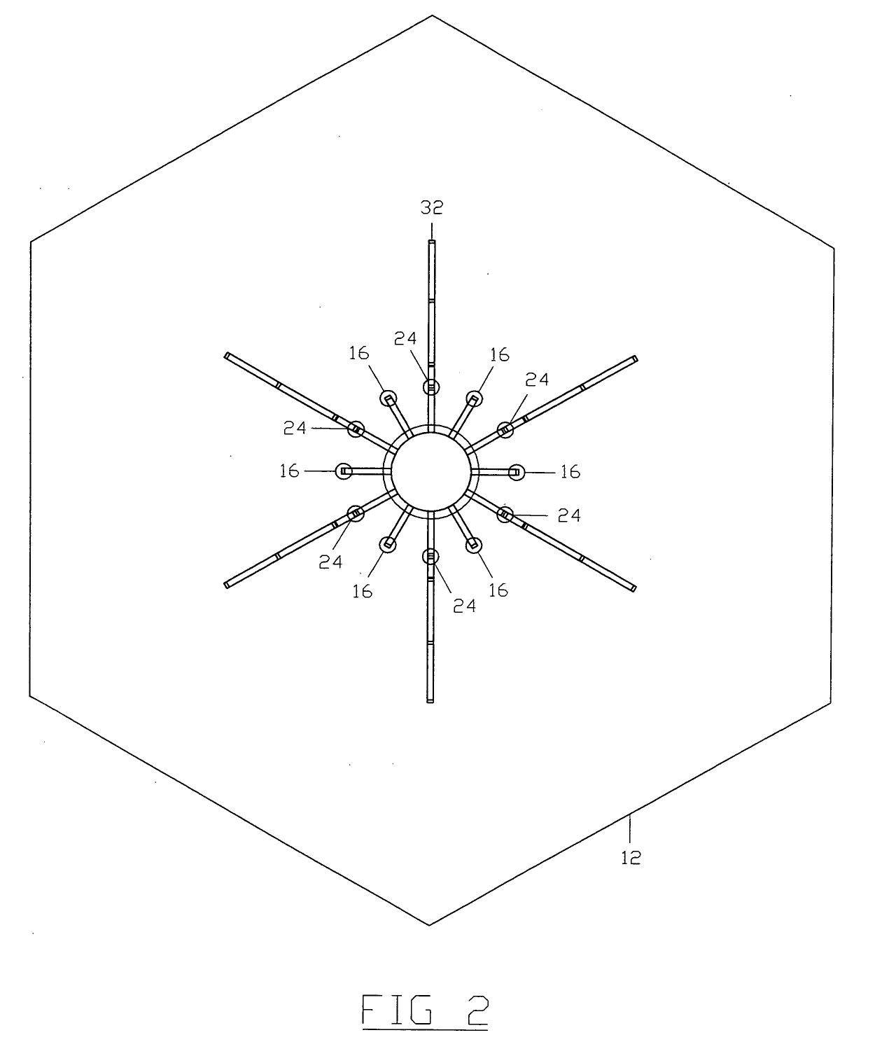

FIG. 2 is a diagrammatic plan view of the apparatus of FIG. 1;

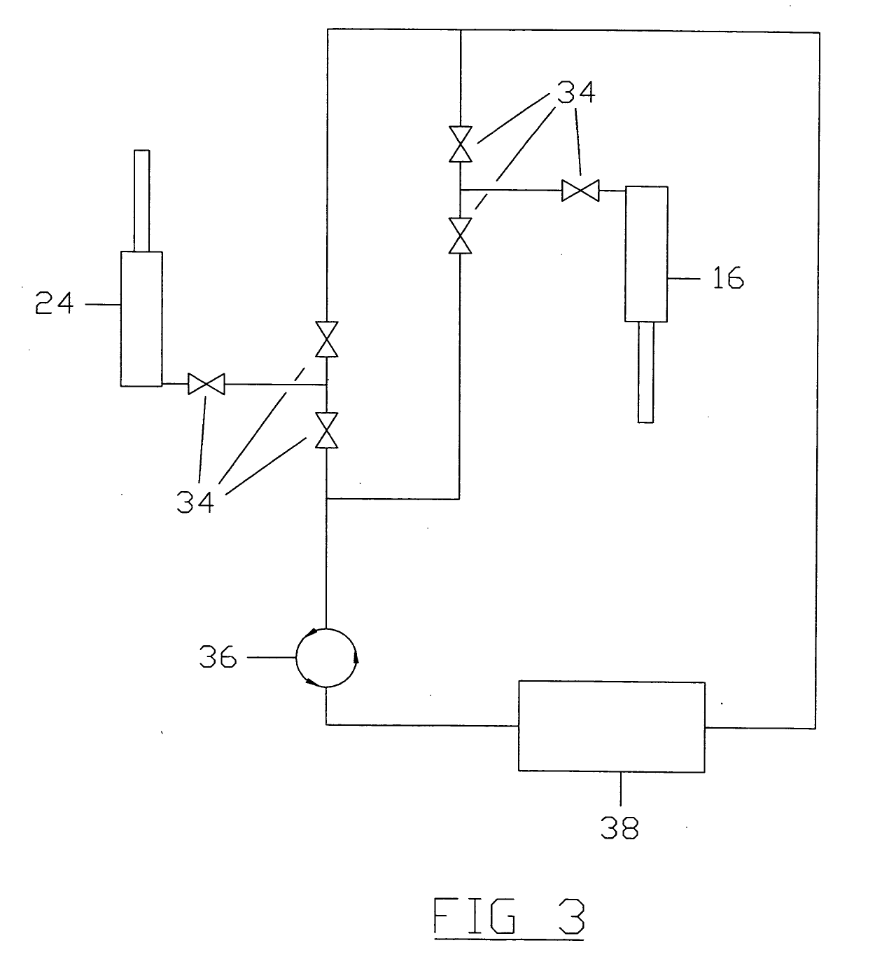

FIG. 3 is a schematic view of part of the apparatus of FIG. 1;

FIG. 4 is a diagrammatic plan view of part of a power generating arrangement according to the invention;

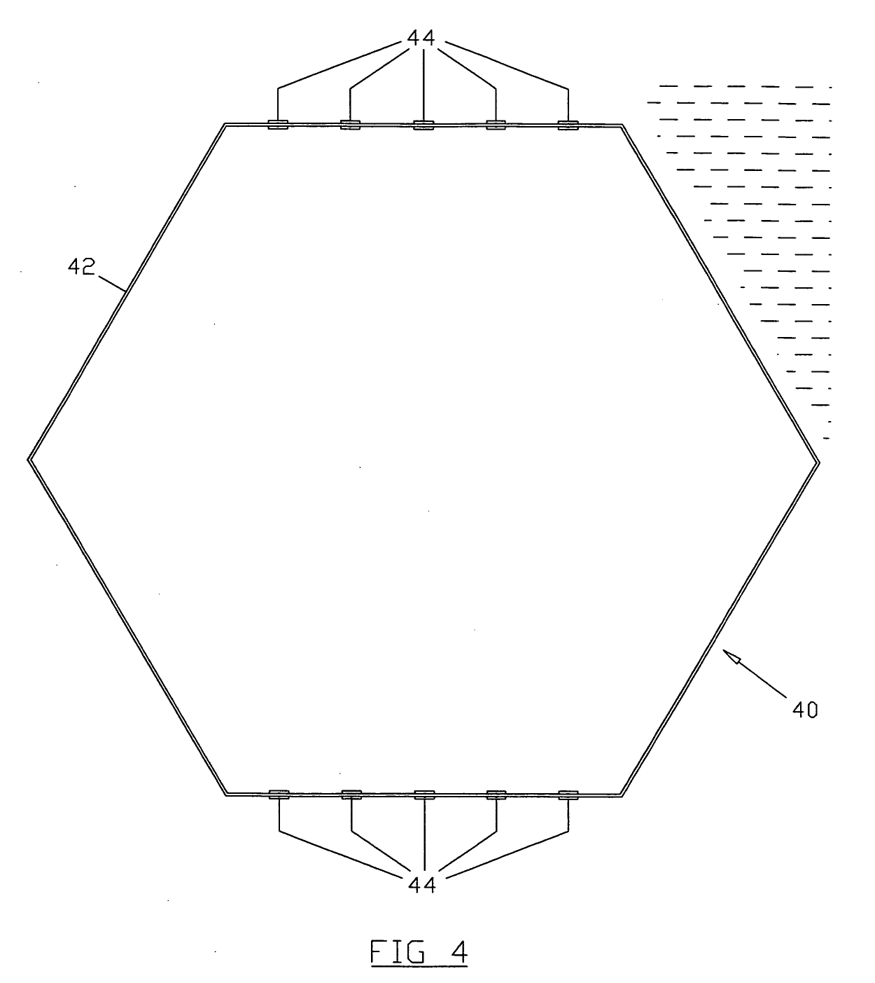

FIGS. 5-10 are respectively diagrammatic views of the arrangement of FIG. 4 in different operating positions;

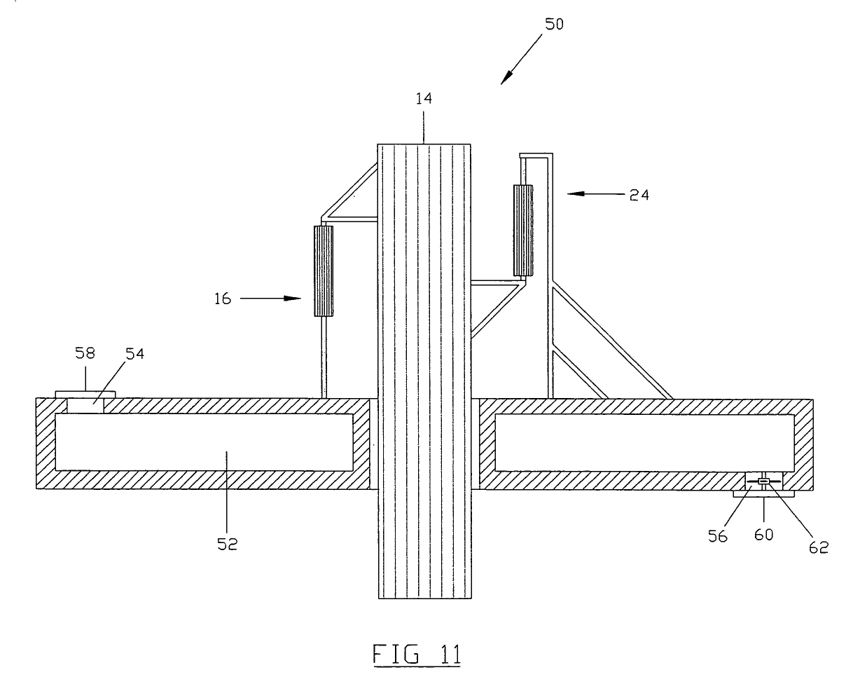

FIG. 11 is a similar view to FIG. 1 but of a second power generating apparatus;

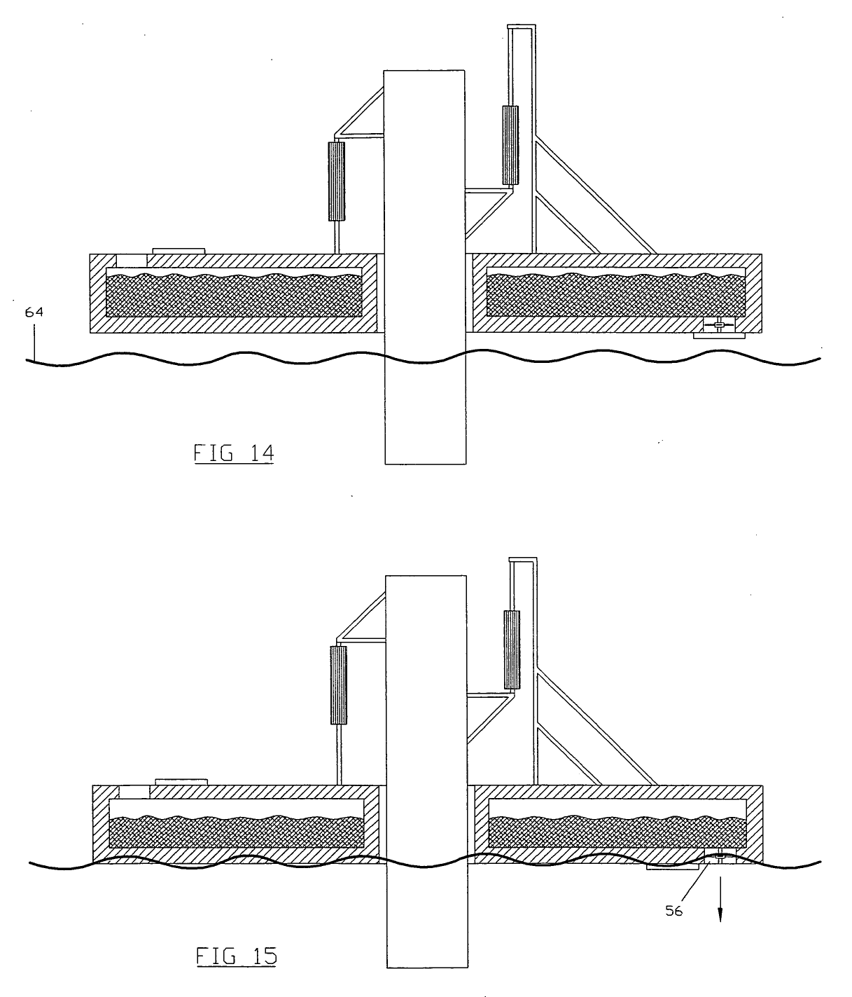

FIGS. 12-15 are diagrammatic cross sectional side views of the apparatus of FIG. 11 in use in different operating positions;

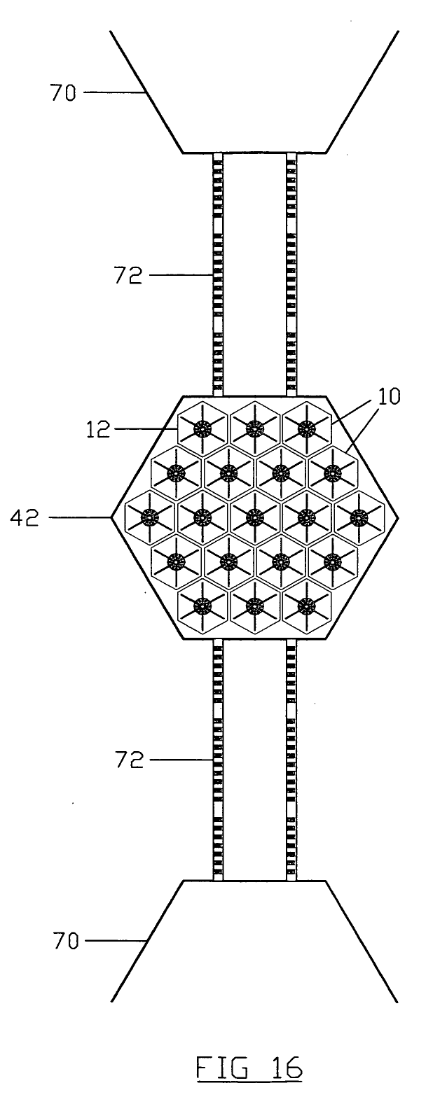

FIG. 16 is a diagrammatic plan view of a first power generating assembly according to the invention;

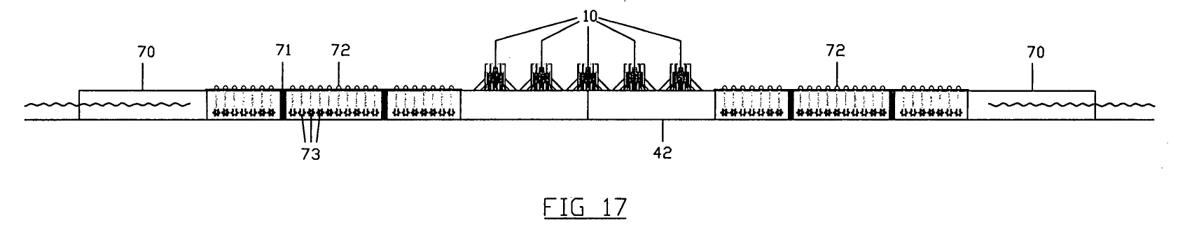

FIG. 17 is a diagrammatic side view of the assembly of FIG. 16;

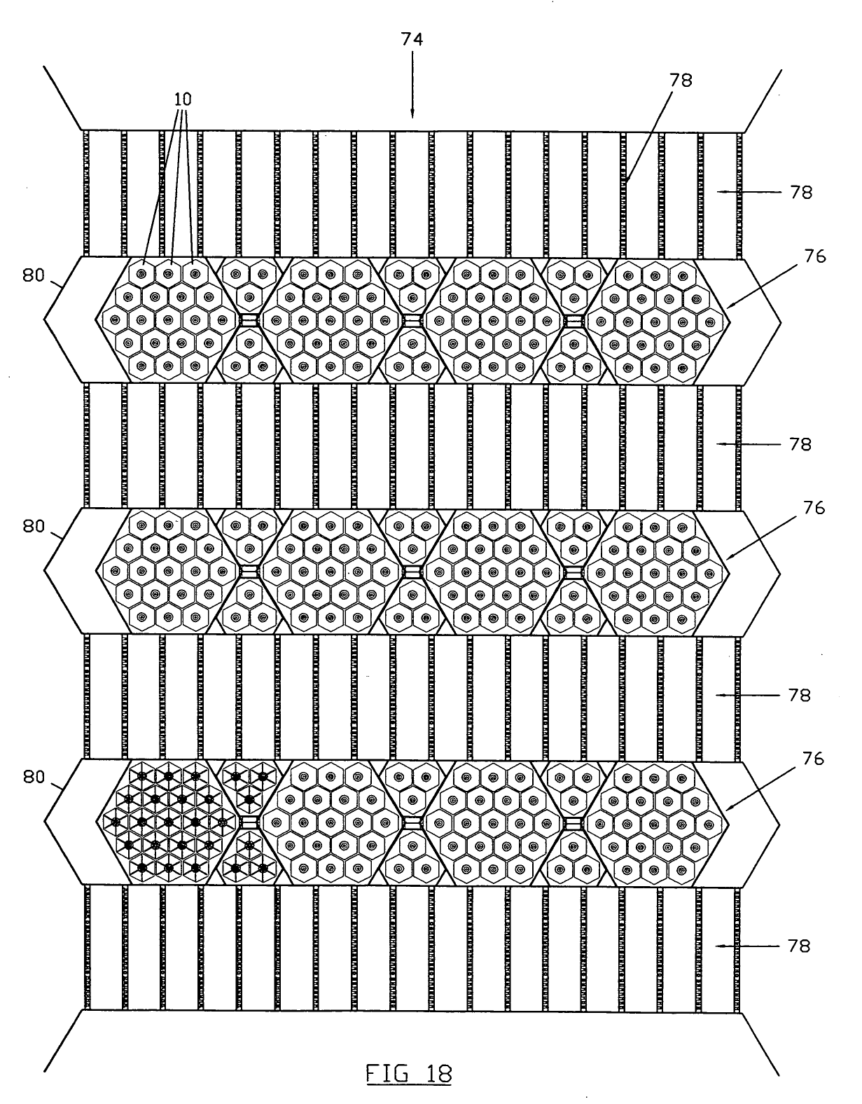

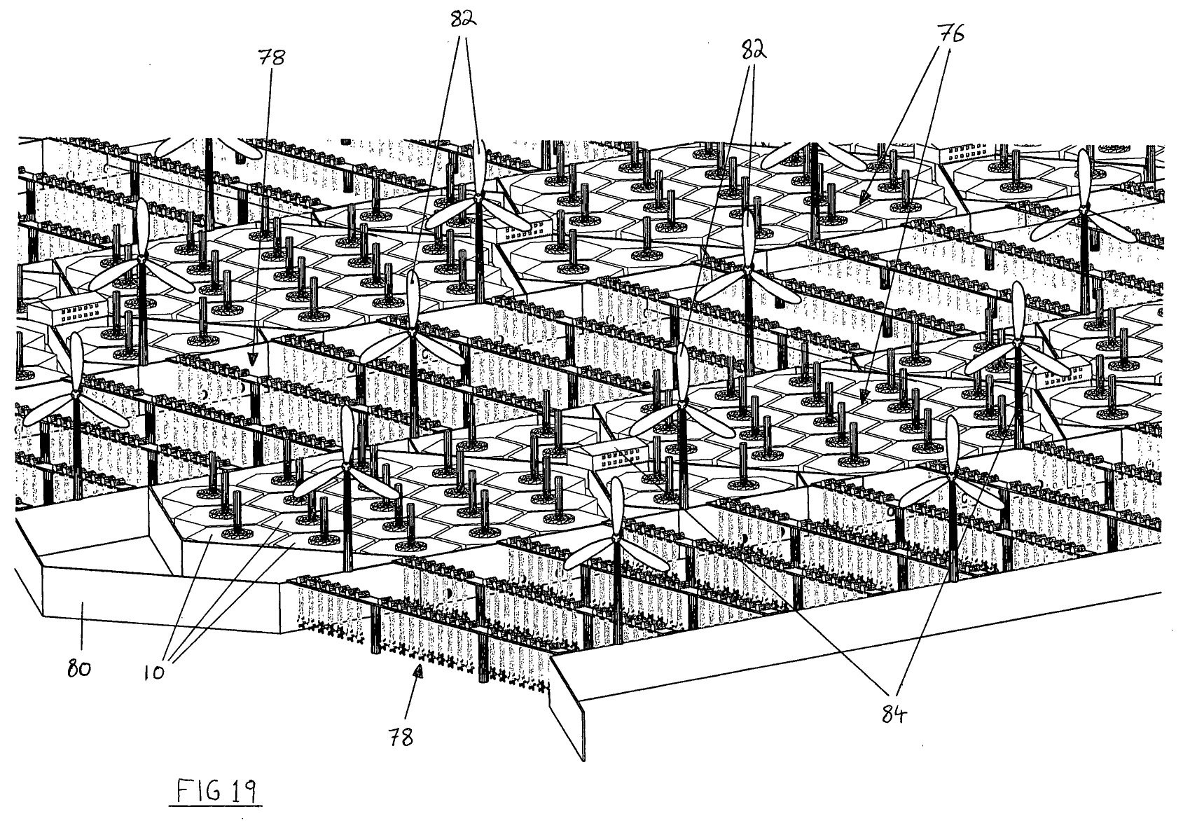

FIG. 18 is a diagrammatic plan view of a second power generating assembly according to the invention;

FIG. 19 is a diagrammatic perspective view of part of the assembly of FIG. 18; and

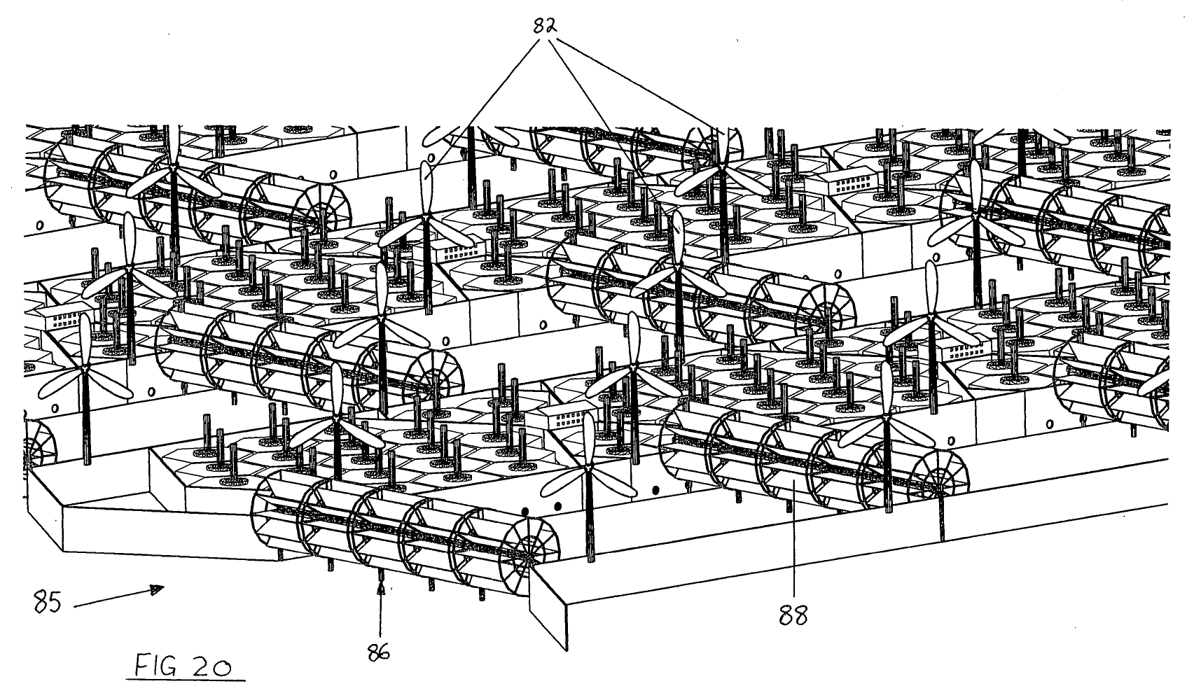

FIG. 20 is a diagrammatic perspective view of part of a third power generating assembly according to the invention.

FIGS. 1-3 show a power generating unit 10 according to the invention for generating electricity from tidal movement of water. The unit 10 comprises a float 12 which is hexagonal in plan view. The float 12 is slidably mountable about a central hole on a cylindrical support member 14 which is mountable to upstand from the sea or a river bed such that the float 12 can slidably move in a vertical direction.

Six first piston and cylinder arrangements 16 are provided extending between a mounting frame 18 on the support member 14 which mounts the cylinder 20 of the arrangement with the piston rod 22 extending downwardly therefrom and mounted to the float 12. Six second piston cylinder arrangements 24 are also mounted between the support member 14 and float 12. The second arrangements 24 comprise a mounting frame 26 on the support member 14 lower than the mounting frame 18 and mounting an upwardly facing cylinder 28. A piston rod 30 extends upwardly from the cylinder 28 and is connected by a further mounting frame 32 to the float 12.

Each of the piston and cylinder arrangements 16, 24 are connected respectively through isolation valves 34 to a hydraulic motor 36 and also a buffer tank 38. The piston and cylinder arrangements, 16, 24 are hydraulic and can use purified sea water. FIG. 3 shows the hydraulic arrangement. The hydraulic motor 36 connects through a gear box to an electricity generator. When the float 12 is to move down the respective isolation valves 34 are opened and sea water is pumped as a result of downward movement of the float and hence the piston rods 30, through the hydraulic motor 36 and into the tank 38. When the float moves upwardly the respective isolation valves 34 will be open such that the cylinders 28 can be filled from the tank 38 as the piston rods 30 move upwardly.

FIG. 4 shows part of a power generating arrangement 40. The part here is an enclosure 42 made of reinforced concrete. The enclosure 42 is hexagonal in plan view and will usually be open topped with a closed base. During installation, the enclosure 42 can usually be floated on the sea to a required position and then sunk by filling with ballast such as sand or rock. Five inlets 44 are provided in each of the top and bottom faces as shown in FIG. 4 of the enclosure 42. Each inlet 44 is provided with a selectively operable closure 43 and also a flow power generator 45 such that water can be selectively allowed to enter or leave the enclosure 42, and as water passes through the inlets 44 electricity or hydraulic power will be produced by the generator 45.

FIGS. 5-10 sequentially show operation of the arrangement 40 which will include an enclosure 42 within which will be located one or more power generating units 10 as shown in FIGS. 1-3. In FIG. 5 it is substantially low tide, with the water level 46 outside of the enclosure 42 substantially equal to the water level 48 therein. The closures 43 in the inlets 44 are closed.

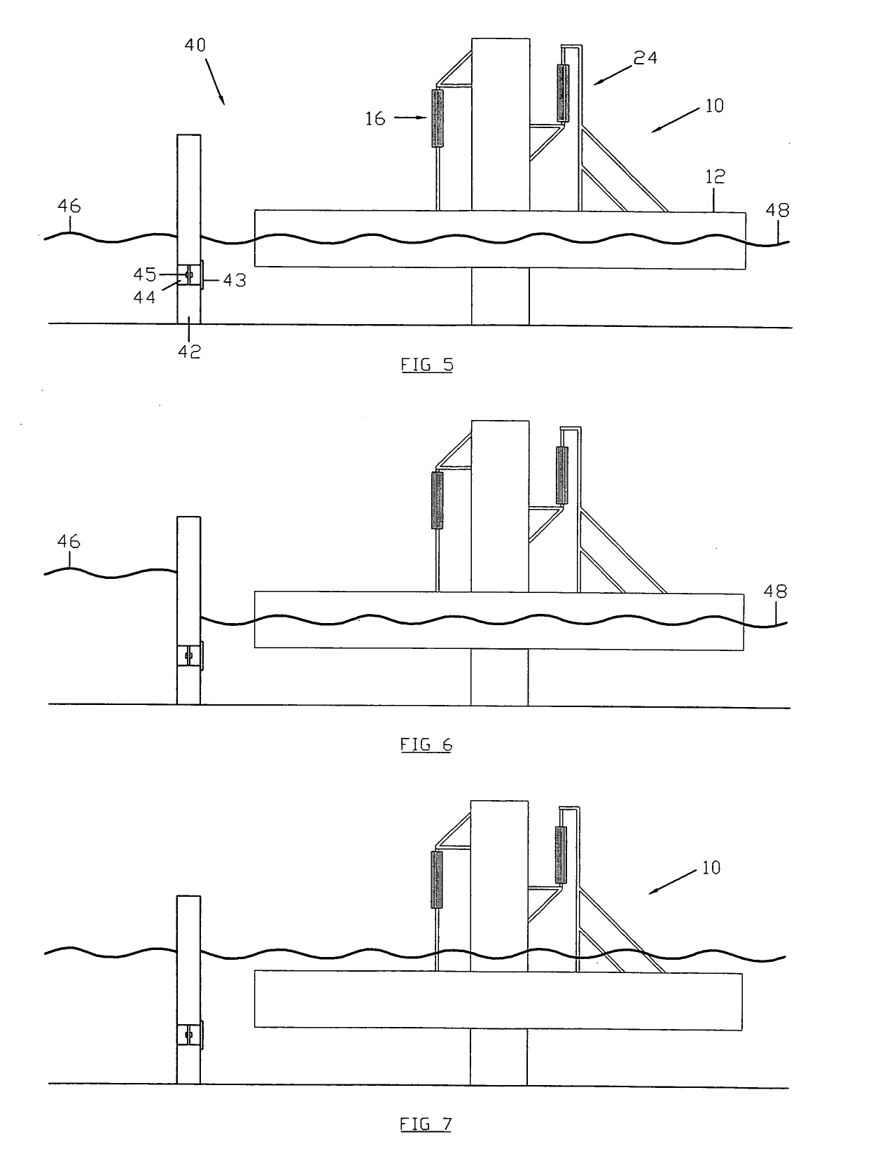

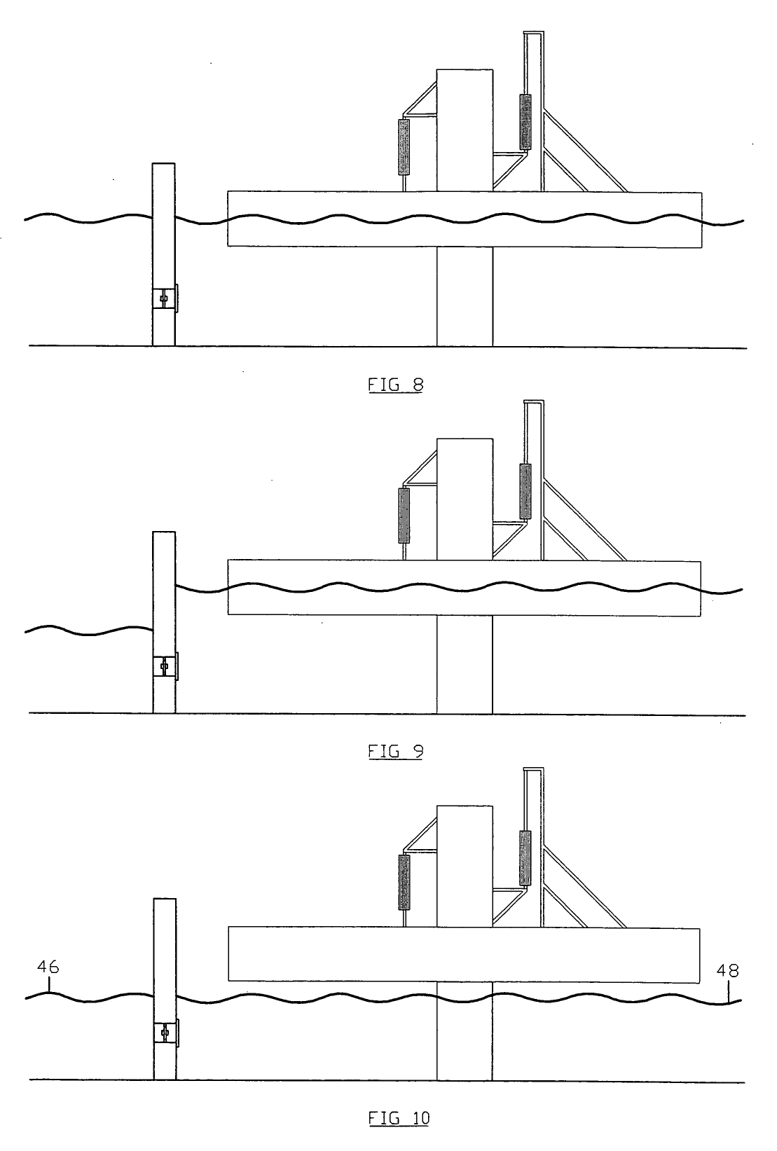

FIG. 6 shows the tide having risen such that the water level 46 is above the water level 48. The closures 43 are then opened to bring the water level 48 up to the level 46, and electricity will be generated as water passes through the flow power generators 45. The float 12 may be allowed to instantly rise with the water level 48 to the position shown in FIG. 8. Alternatively the float may be retained as required by closing the isolation valves 34 to the first piston and cylinder arrangements 16, such that movement of the piston rods 22 is prevented thereby restraining movement of the float 12 to provide the configuration shown in FIG. 7. Once the isolation valves 34 have been opened the float 12 will rise to the position shown in FIG. 8.

FIG. 9 shows the position where the outside water level 46 has dropped to substantially low tide. As the closures 43 are closed, the inner water level 48 has not yet dropped. The closures 43 are then opened allowing the inner water level 48 to drop to equal the outer water level 46 as shown in FIG. 10, and again producing electricity by virtue of the generators 45. The float 12 can be retained in a raised position if required by closing the isolation valves 34 on the second piston and cylinder arrangement 24. When these are open the float 12 will drop thereby producing electricity.

FIGS. 11-15 show a second power generating unit 50 which is similar to the unit 10 except that a hollow float 52 is provided. The float 52 includes upper and lower inlets 54, 56 controlled by respective valves 58, 60. The valve 60 in the lower inlet also includes a flow power generator 62.

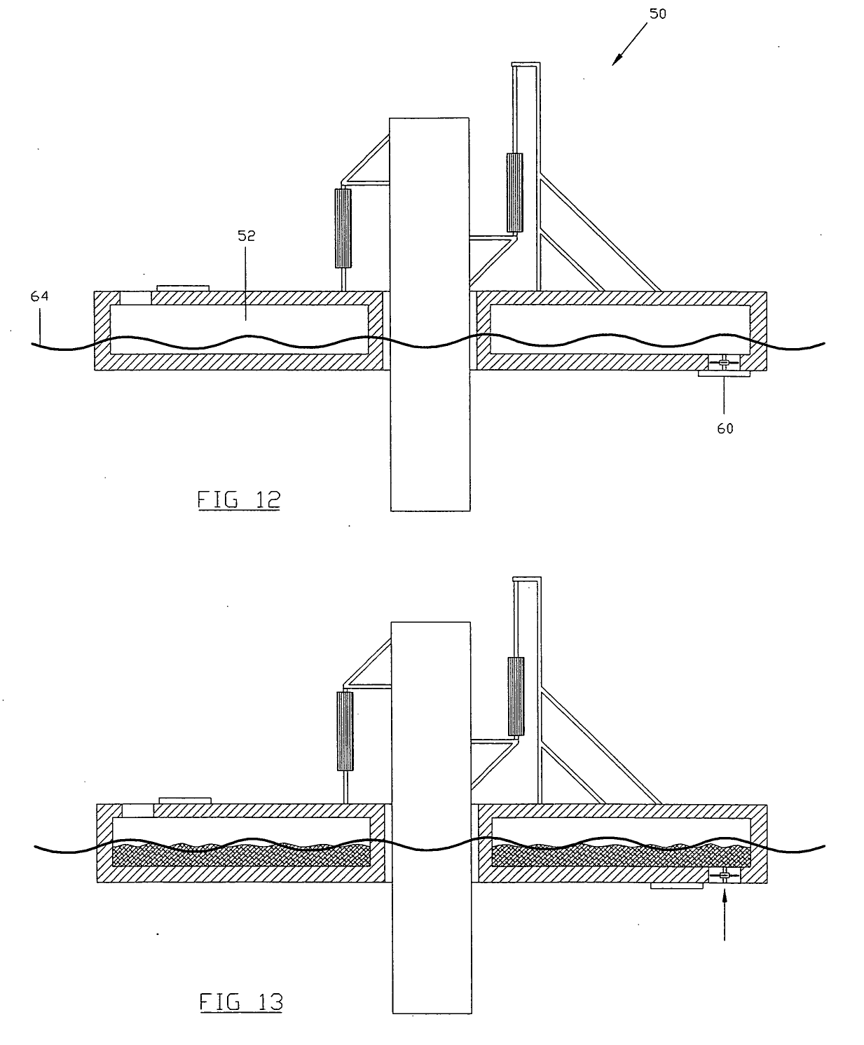

FIGS. 12-15 show operation of the unit 50. At high tide the float 52 contains air and floats on top of the water level 64 (FIG. 12). With the float 52 retained in this upper position by the respective isolation valves 34, the valves 58, 60 are opened to allow water to enter into the interior of the float 52 (FIG. 13) through the lower end 56 thereby producing electricity with the flow power generator 62. Air within the float 52 is expelled through the upper inlet 54.

At least the lower valve 60 is then closed and the float 52 retained in the upper position as shown in FIG. 14 as the water level 64 drops at low tide. The float 52 is then allowed to drop by releasing the isolation valves 34 on the second piston and cylinder arrangements 24. The extra weight of the float 52 due to the water therein provides for greater power generation. If the float 52 is retained a little above the low tide position, the water therein can be allowed to drain through the lower inlet 56 again producing electricity through the flow power generator 62. The lower valve 60 at least can then be closed to allow the float 52 containing air, to again flow upwardly as the high tide comes in.

It is generally envisaged that a plurality of power generating units 10 or 50 would be provided together. An arrangement is shown in FIGS. 16 and 17, with a plurality of adjacent power generating units 10 in a single enclosure 42. The hexagonal shape of the floats 12 provides for close packing as shown in FIG. 16.

The units 10, 50 and closures 43 for the enclosure 42 are computer controlled by a program with tide details to ensure correct operation. The units 10, 50 and/or the closures 43 in the enclosure 42 may be operated to sequentially operate one after another to provide electricity generation over a substantial period of time.

FIGS. 16 and 17 show an assembly located in an estuary with barriers 70 at each side of the estuary and a collection of power generating units 10 located within the enclosure 42, midway between the barriers 70 and spaced therefrom. Between the enclosure 42 and the barriers 70 a plurality of tidal turbines 72 are provided to further produce electricity. The turbines 72 comprise a support bridge 71 which supports a plurality of submerged propellers 73 rotatable by the tidal water flow. The tidal turbines 72 particularly produce electricity between low and high tides for a number of hours, while the power generating units 10 can be particularly used to generate electricity towards high and low tides.

FIGS. 18 and 19 show a further power generating assembly 74 of a much larger scale. Here three banks 76 of groups of power generating units 10 are interposed between groups of tidal turbines 78. The units 10 are arranged in groups within respective enclosures. Extra barrier walls 80 are provided at each end of the banks 76 to provide additional protection for the units 10 from waves and potentially also shipping. A plurality of wind turbines 82 are also provided spaced from each other on the banks 76 along with buildings 84 locating appropriate electricity handling equipment such as transformers etc.

FIG. 20 shows part of a further power generating assembly 85, which is generally similar to the assembly 74. Here however, the tidal turbines 86 are of a different type and include paddles 88 which are only partially submerged in the water. It is to be realised that other types of tidal turbines could be used. Another possible type is a submerged vertically mounted cylindrical turbine.

The invention thus provides power generating units which permit tidal energy to produce electrical power in a controlled manner. The assemblies described illustrate how such units can be combined with tidal turbines and perhaps also wind turbines to provide integrated electricity generating assemblies where power will be generated over a large proportion of the time, and with much of this power generation being predictable and consistent.

Various other modifications may be made without departing from the scope of the invention. For instance the power generating units may operate in a different manner and could operate other than by hydraulic piston and cylinders. For instance rotational and/or pivotal movement could be achieved by the vertical movement of the floats. A wide range of different assemblies could be produced dependent on local geographical and other considerations.

The floats may be a different shape to hexagonal, and respective enclosures could be shaped accordingly. A different number and/or arrangement of openings into the enclosures may be provided.

The rate of rise or descent of the floats can be controlled if required. The wind and tidal turbines may produce electricity, or could create hydraulic power to feed the plant's hydraulic system. The propeller type of tide turbines could have diverters and/or ducting to urge water onto the propellers.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A power generating apparatus combining; tidal height energy accumulators, a selectively isolated chamber system and a venturi enhanced tidal flow energy generating device.

2. A power generating apparatus as claimed in claim 1 where tidal height energy accumulators generate power on both the rise and fall of the tide.

3. A power generating apparatus as claimed in claim 1 & 2 where tidal height energy accumulators can be selectively restrained in either high or low position.

4. A power generating apparatus as claimed in claims above where tidal height energy accumulators can be selectively flooded or discharged of water ballast.

5. A power generating apparatus as claimed in claims above where tidal height energy accumulators utilize a hydraulic system for power transmission.

6. A power generating apparatus as claimed in claim 1 where tidal height energy accumulators are located within chamber system, allowing selective isolation from tidal height changes.

7. A power generating apparatus as claimed in claim 1 where chamber system generates power from water flow in and out of enclosed areas.

8. A power generating apparatus as claimed in claim 1 where tidal height energy accumulators and chamber system can be operated sequentially to give a controlled power output.

9. A power generating apparatus as claimed in claim 1 where tidal height energy accumulators and chamber system can be of modular construction, allowing a plurality of units to be combined together.

10. A power generating apparatus substantially as herein described above and illustrated in the accompanying drawings.
